(19) United States
(12) Patent Application Publication
(10) Pub. No.: US 2025/0196048 A1
(43) Pub. Date: Jun. 19, 2025

(54) GRAPHENE AS A STATIONARY PHASE IN GAS CHROMATOGRAPHY

(71) Applicant: The Regents of the University of Michigan, Ann Arbor, MI (US)

(72) Inventors: Xudong FAN, Ann Arbor, MI (US); Zhaohui ZHONG, Ann Arbor, MI (US); Wenzhe ZANG, Ann Arbor, MI (US); Hongbo ZHU, Johnson City, TN (US); Zhe LIU, Ann Arbor, MI (US); Girish KULKARNI, Ann Arbor, MI (US)

(73) Assignee: The Regents of The University of Michigan, Ann Arbor, MI (US)

(21) Appl. No.: 18/848,746

(22) PCT Filed: Mar. 9, 2023
(86) PCT No.: PCT/US2023/014885

§ 371 Date: Sep. 19, 2024

Related U.S. Application Data
(60) Provisional application No. 63/322,456, filed on Mar. 22, 2022.

(51) Int. Cl. B01D 53/02; B01D 53/30; B01J 20/20; B01J 20/281; G01N 30/02; G01N 30/30

(52) U.S. Cl. CPC B01D 53/025; B01D 53/30; B01J 20/205; B01J 20/281; G01N 30/30; B01D 2253/102; B01D 2259/40096; B01J 2220/86; G01N 2030/025

(57) ABSTRACT

Gas chromatography (GC) relies on the interaction of vapor molecules with the stationary phase coated on the column inner wall to separate different vapor molecules. Here, graphene is integrated as the ultrathin and electrically tunable stationary phase within a GC column. Graphene has different interactions with different vapor molecules, which leads to separation of those vapor molecules. In addition, by configuring graphene into a field effect transistor (FET) design, the molecule-graphene interaction can be controlled or tuned by adjusting the graphene Fermi level through the FET gate voltage. As a result, the binding energy between graphene and adsorbed vapor molecules can be tuned and hence the elution time and/or elution order of vapor molecules can be changed.

### GOVERNMENT SUPPORT CLAUSE

This invention was made with government support under IARPA 2018-18032000001 awarded by the Office of the Director of National Intelligence-Intelligence Advanced Research Projects Activity. The government has certain rights in the invention.

### FIELD

The present disclosure relates to gas chromatography.

### BACKGROUND

Gas chromatography (GC) is the gold standard analytical tool in gas analysis. Gas chromatography relies on the interaction of vapor molecules with the stationary phase coated on the column inner wall to separate different vapor molecules. The mobility of the vapor molecule, u, in the column is determined by μ=1/(1+k), where k is the retention factor and is determined by the desorption rate of the molecules from the stationary phase. The vapor retention time, t, is governed by its mobility, i.e., t=L/μ, where L is the column length. Different interaction strengths with the stationary phase result in different vapor desorption rates and hence different mobilities and retention times.

Temperature programmed gas chromatography is one of the most commonly used schemes in gas chromatography. During operation, temperature is ramped over time to change the desorption rate and hence retention factor and mobility. Consequently, vapor species are eluted out at different times depending on their specific temperatures. In comparison with isothermal gas chromatography separation, temperature programmed gas chromatography is fast and efficient (more peaks per unit time), and the eluted peaks are more symmetric. However, one of the major issues with temperature programmed gas chromatography is power consumption. The gas chromatography column needs to be heated to a few hundred ° C. for operation and later be cooled down for the next round of analysis, which requires not only tremendous amount of energy, but also relatively long time (due to finite thermal mass, particularly in the cooling stage). In addition, both the heating and the cooling modules may involve complicated components that add more weight and cost to the gas chromatography system. Finally, repeated heating to a high temperature may cause the stationary phase to wear or break down, thus affecting the gas chromatography performance and adding the gas chromatography operation/maintenance costs.

While the above drawbacks may be acceptable for bench-top gas chromatography located in labs, they become key limiting factors for one or a combination of the following application scenarios: (1) power budget is very limited; (2) rapid analysis is needed; (3) short turn-around time is needed; (4) long-term automated monitoring is needed, in which the stationary phase degrades over time due to heating and cannot be replaced easily.

This section provides background information related to the present disclosure which is not necessarily prior art.

### SUMMARY

This section provides a general summary of the disclosure, and is not a comprehensive disclosure of its full scope or all of its features.

A separation column is presented for use in gas chromatography. The separation column is comprised of an enclosure formed on the substrate, where the enclosure provides an inlet configured to receive an analyte of interest, an outlet and a flow channel defined between the inlet and the outlet; and graphene disposed on at least one surface defining the flow channel in the enclosure. The flow channel preferably has a serpentine shape.

In one aspect, the separation column includes a temperature tuning mechanism disposed proximate to the flow channel, where the temperature tuning mechanism operates to change ambient temperature and thereby controls analyte's desorption rate in the flow channel.

In another aspect, the separation column includes: a gate electrode electrically coupled to the graphene; a drive source electrically coupled to the gate electrode and configured to apply a DC voltage thereto; and a controller interfaced with the drive source, where the controller adjusts magnitude of the DC voltage applied to the gate electrode and thereby controls analyte's desorption rate in the separation column.

In some embodiments, the separation column further comprises a field effect transistor having a source electrode, a channel region, and a drain electrode, where the graphene forms the channel region of the field effect transistor.

In some embodiments, the separation column further comprises a delivery mechanism fluidly connected to the inlet of the enclosure and introduces the analyte of interest into the flow channel of the enclosure.

The separation column is preferably integrated into a gas chromatograph, where the gas chromatograph may include a preconcentrator fluidly connected between the delivery mechanism and the separation column, and the preconcentrator includes a chamber through which the analyte passes and sorbent material in the chamber.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a graph showing the binding energy in relation to the distance between the graphene and a vapor molecule.

FIG. 2A is a chart showing energy scales for covalent and noncovalent molecular interactions.

FIG. 2B is a graph showing the Fermi energy in relation to the density states for common one-dimensional materials such as carbon nanotube and two-dimensional materials such as graphene and MoS2.

FIG. 3 is a diagram depicting an example embodiment of a separation column in accordance with this disclosure.

FIGS. 4A and 4B are graphs showing the binding energy change as a function of the Fermi energy change for chloroform and DMF, respectively.

FIG. 5 is a graph showing effective temperature change as a function of the gate voltage change for chloroform and DMF.

FIG. 6 is a diagram depicting another example embodiment of a separation column in accordance with this disclosure.

FIG. 7 is a block diagram of an example gas chromatograph.

FIG. 8 illustrates a complex monolithic gas chromatography system.

FIGS. 9A-9C are graphs showing Vg-dependent single-species chromatogram of CH₂Cl₂, acetone, and chlorobenzene at different graphene Fermi level shift.

FIGS. 10A and 10B are graphs showing the retention factor and the number of plates of CH₂Cl₂, CHCl₃, acetone and DMF.

FIG. 11 is a graph showing Vg-dependent chromatogram of mixture of chloroform, acetone, chlorobenzene and four alkanes.

FIG. 12 is a graph showing chromatogram of single analyte injection and mixture injection in a control experiment.

Corresponding reference numerals indicate corresponding parts throughout the several views of the drawings.

### DETAILED DESCRIPTION

Example embodiments will now be described more fully with reference to the accompanying drawings.

Graphene is a single atomic layer semi-metal with excellent electrical properties. Unlike bulk materials, its low density of states leads to efficient tuning of the Fermi energy through simple electrical field effect gating, which can be exploited for controlling the non-covalent interaction between vapor molecules and graphene. Applicants studied the interaction between graphene field effect transistor (Gr-FET) and the vapor molecules near its surface and found that the molecule's desorption rate can be significantly modified by the gate voltage applied to the Gr-FET.

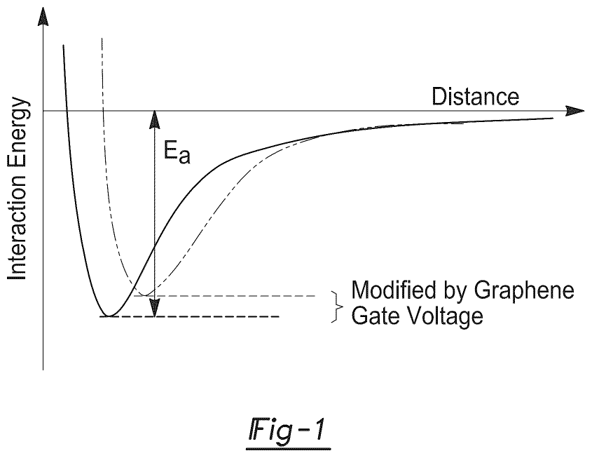

Molecular desorption rate, k_{des} is governed by the binding energy (E_{bind}) and temperature (T) through

$${k}_{des} = {v}_{f} exp ( \frac{- {E}_{bind}}{{k}_{B} T} ) , \qquad ( 1 )$$

where v_{f} is the attempt frequency and k_{B} is the Boltzmann constant. Therefore, the desorption rate can be changed by either temperature or binding energy. For graphene, the binding energy between graphene and molecules can be tuned by changing the graphene Fermi energy through gate voltage tuning, i.e.,

$${k}_{des} = {v}_{f} exp ( \frac{- {E}_{bind , 0} + f ( {E}_{F} )}{{k}_{B} T} ) , \qquad ( 2 )$$

where E_{bind,0} is the binding energy when no gate voltage is added. f(E_{F}) is the increase or decrease in the binding energy when the gate voltage is applied. E_{F} is the Fermi energy given by

$${E}_{F} = ℏ {v}_{Fermi} \sqrt{π n} , \qquad ( 3 )$$

where h is the Planck constant, and V_{F} the Fermi velocity in graphene. n is the charge density of graphene given by

$$n = \vert \frac{{C}_{bg} ( {V}_{g} - {V}_{D} )}{e} \vert , \qquad ( 4 )$$

where e is the charge of an electron. C_{bg} is the back-gate capacitance for graphene device, and V_{D} is charge-neutral point voltage. C_{bg} can be calculated by

$${C}_{bg} = \frac{{ε}_{0} {ε}_{{SiO}_{2}}}{d} , \qquad ( 5 )$$

where ε_{SiO2} and d are the dielectric constant and thickness of the silicon oxide layer below the graphene layer, respectively. Through Eqs. (2)-(5), it is clear that by tuning the graphene gate voltage V_{g}, the molecule's desorption rate from the graphene surface can be tuned, which is illustrated in FIG. 1.

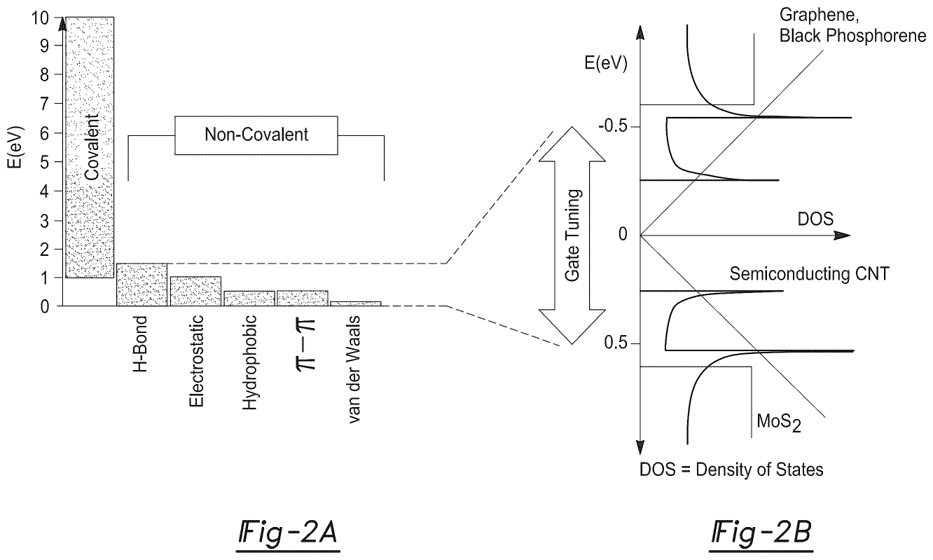

The behavior of molecules near a surface is dictated by the interplay of attractive and repulsive forces between the two, and these interactions can be classified as either chemical (covalent/ionic) or physical (noncovalent). As shown in FIG. 2A, covalent interactions involve sharing of electrons between the two systems and are strong with binding energies between 1 and 10 eV. The binding is usually irreversible. On the other hand, the binding energy for electrostatic noncovalent is only a few 100 meVs and the binding is reversible. It is the nonconvalent interactions that are typically used in a GC column to retain and hence separate vapor molecules.

As shown in FIG. 2B, the range of gate tunability for Fermi energy in a typical nanomaterial is on the order of ±0.5 eV, which conveniently covers the energy range for weak noncovalent interactions. Furthermore, graphene is particularly attractive as a platform for studying noncovalent molecular physisorption. Its perfect lattice ensures physisorption nature for molecular adsorption, and its linear band dispersion also enables a continuous gate tuning of the Fermi energy level. While particular reference is made throughout this disclosure to graphene, it is envisioned that other nanomaterials may be suitable for use as stationary phase as well.

The equilibrium of vapor molecule distribution between the stationary phase and the mobile phase can be described by the distribution constant (or partition coefficient):

$$K = \frac{{C}_{s}}{{C}_{m}} , \qquad ( 6 )$$

where Cₛ and Cₘ are the concentration of the vapor molecules in the stationary and the mobile phase, respectively. Macroscopically and thermodynamically,

$$K = exp ( \frac{Δ G}{RT} ) , \qquad ( 7 )$$

where ΔG is the Gibbs free energy change when the vapor molecules transfer from the stationary phase to the mobile phase. R is the gas constant and is related to the Boltzmann constant, k_{B}, by R=k_{B}×N_{A}, where N_{A} is the Avogadro constant.

On the other hand, from a microscopic point of view, the kinetics of vapor molecules absorbed to and desorbed from the graphene stationary phase can be described by:

$$\frac{{dC}_{s}}{dt} = - {k}_{des} {C}_{s} + {k}_{ads} {C}_{m} , \qquad ( 8 )$$

where k_{des} and k_{ads} are the desorption rate (see Eq. (2)) and the adsorption rate, respectively. k_{ads} is assumed to be constant regardless of temperature. Considering Eqs. (2) and (6), and at equilibrium, it follows

$$K = \frac{{C}_{s}}{{C}_{m}} = \frac{{k}_{ads}}{{k}_{des}} = ( {v}_{f} {k}_{ads} ) exp [ \frac{{N}_{A} ( {E}_{bind , 0} - f ( {E}_{F} ) )}{RT} ] . \qquad ( 9 )$$

Comparing Eqs. (7) and (9), one can see that these two equations are equivalent and describe the same distribution constant from a macroscopic (thermodynamic) and microscopic (molecular) perspective, respectively. Changing the gate voltage of the graphene stationary phase is equivalent to the traditional way of changing the temperature in a column's stationary phase.

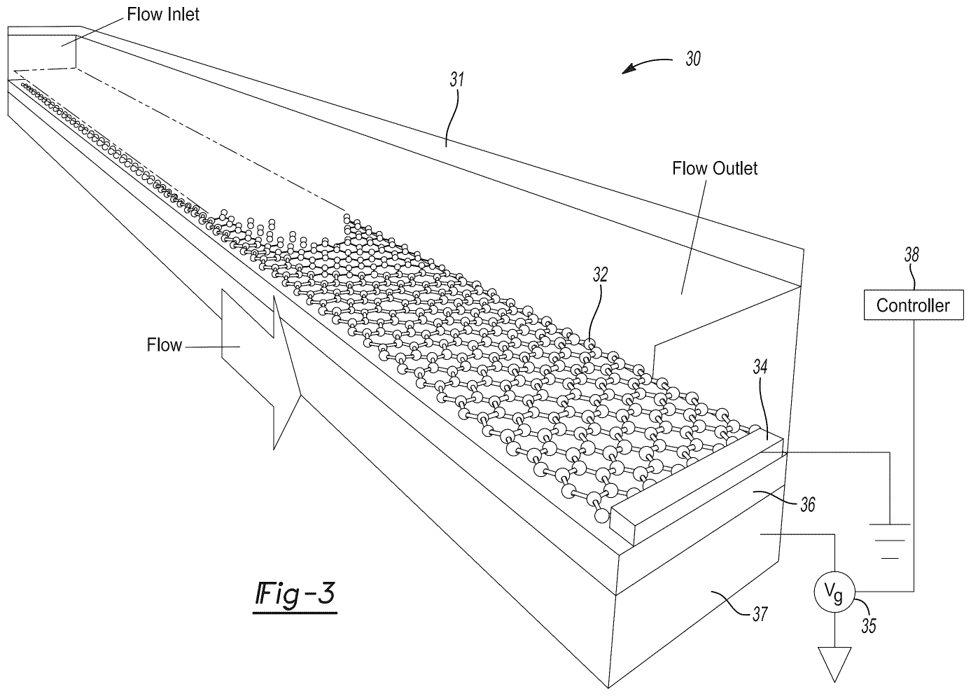

FIG. 3 depicts an example embodiment of a separation column 30 in accordance with this disclosure. The separation column 30 is comprised of an enclosure 31 having an inlet, an outlet, and a flow channel defined between the inlet and the outlet. The inlet is configured to receive an analyte of interest which flow through the flow channel. In the example embodiment, graphene 32 is disposed on at least one surface defining the flow channel in the enclosure. The use of graphene as a stationary phase is believed to be novel. In other embodiments, this disclosure envisions the use of other types of nanomaterials.

In some embodiments, a gate electrode 34 is electrically coupled to the graphene 32; and a drive source 35 is electrically coupled to the gate electrode 34, where the drive source 35 is configured to apply a DC voltage to the gate electrode 34. In this example, graphene 32 is disposed on a dielectric 36 which is in turn supported by a substrate 37. At least one other electrode is needed to apply the DC voltage to the gate electrode and a controller 38 is interfaced with the drive source 35. During operation, the controller 38 adjusts magnitude of the DC voltage applied to the gate electrode and thereby controls desorption rate between the analyte of interest and the graphene.

In this disclosure, controlling desorption rate using gate voltage is the preferred tuning mechanism. Desorption rate may also be controlled in the conventional manner using a temperature tuning mechanism, for example implemented by a heater and/or cooling device. That is, the desorption rate may be controlling using gate voltage, temperature tuning or a combination of both.

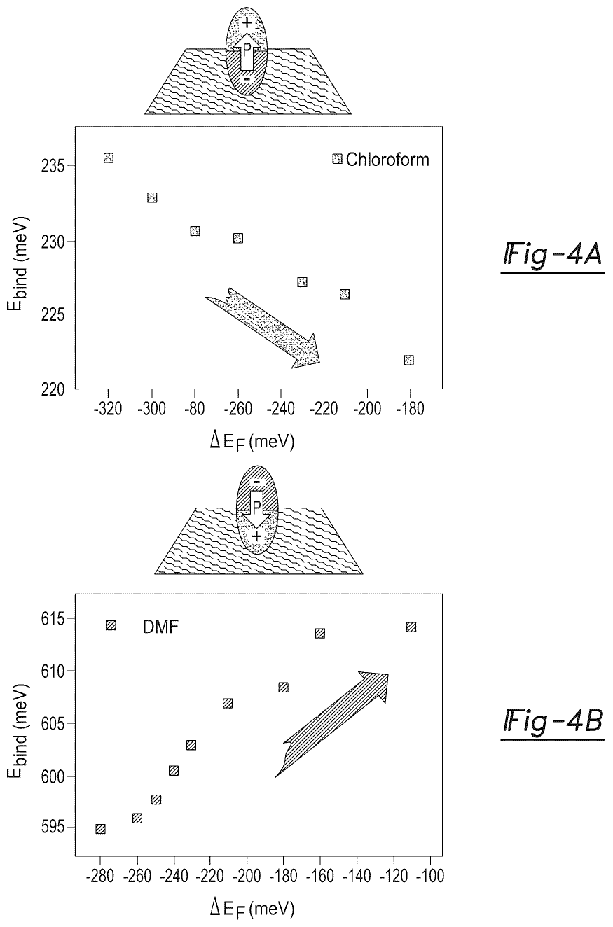

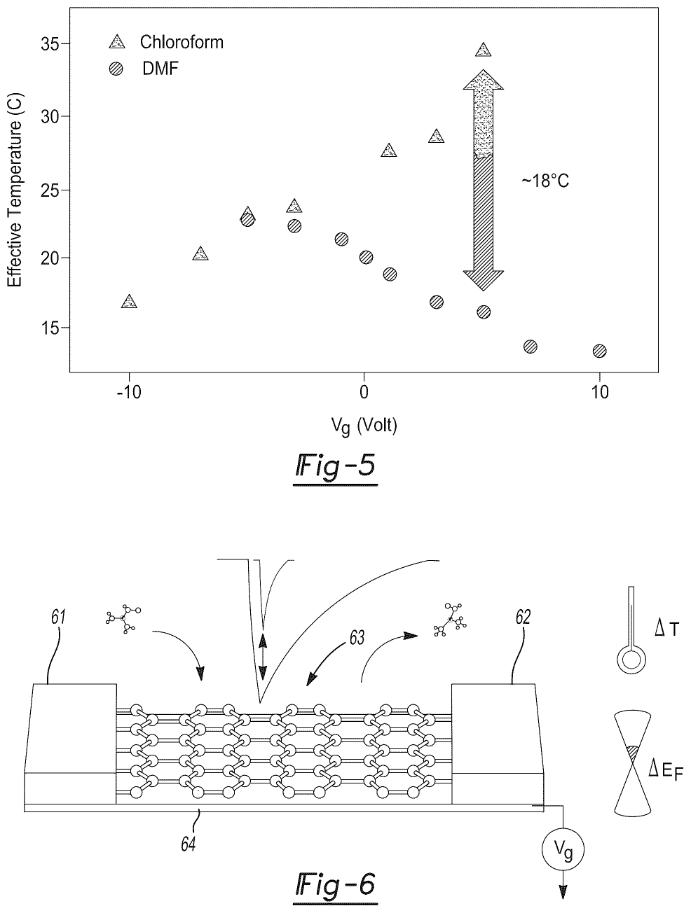

For demonstration purposes, examples of two analytes are further described below. Tables 1 and 2 below present examples of the gate voltage tuned interaction between graphene and vapor molecules of chloroform and DMF, respectively. With reference to Table 1, it is shown that for chloroform when the gate voltage changes from −10 V to 5 V, the binding energy decreases from 235.4 meV to 222.2 meV, effectively increasing the temperature from 16.8° C. to 34.1° C. In contrast, for N,N-dimethylformamide (DMF) when the gate voltage changes from −5 V to 10 V, the binding energy increases from 594.7 meV to 614.2 meV, effectively decreasing the temperature 22.7° C. to 13.4° C. FIGS. 4A and 4B show the binding energy change as a function of the Fermi energy change for chloroform and DMF, respectively, extracted from Tables 1 and 2. The opposite trend is due to the opposite dipole orientation of the molecule on the graphene surface. FIG. 5 shows that the effective temperature can be as large as 18° C. between chloroform and DMF when the gate voltage is set at +5V, even though the actual temperature is kept at room temperature, i.e., 20° C.

TABLE 1

| V_{g} | ΔE_{F} | k_{des}^{exp} (sec⁻¹)at | E_{bind} | Effective |
|---|---|---|---|---|
| (V) | (meV) | room temperature | (meV) | Temperature (° C.) |
| −10 | −320 | 1.16 | 235.4 | 16.8 [symbol] RT − 3.2° C. |
| −7 | −300 | 1.28 | 232.8 | 20.1 |
| −5 | −280 | 1.40 | 230.6 | 22.9 |
| −3 | −260 | 1.42 | 230.2 | 23.4 |
| −1 | −250 | 1.34 | 231.6 | 21.6 |
| 0 | −240 | 1.28 | 232.9 | 20.0 |
| 1 | −230 | 1.59 | 227.3 | 27.2 |
| 3 | −210 | 1.64 | 226.5 | 28.2 |
| 5 | −180 | 1.95 | 222.2 | 34.1 [symbol] RT + 14.1° C. |

TABLE 2

| V_{g} | ΔE_{F} | k_{des}^{exp} (sec⁻¹) at | E_{bind} | Effective |
|---|---|---|---|---|
| (V) | (meV) | room temperature | (meV) | Temperature (° C.) |
| −5 | −280 | 2.39 | 594.7 | 22.7 [symbol] RT + 2.7° C. |
| −3 | −260 | 2.30 | 595.8 | 22.2 |
| −1 | −250 | 2.14 | 597.6 | 21.3 |
| 0 | −240 | 1.93 | 600.3 | 20.0 |
| 1 | −230 | 1.75 | 602.8 | 18.8 |
| 3 | −210 | 1.5 | 606.9 | 16.8 |
| 5 | −180 | 1.42 | 608.3 | 16.1 |
| 7 | −160 | 1.16 | 613.5 | 13.7 |
| 10 | −110 | 1.13 | 614.2 | 13.4 [symbol] RT − 6.6° C. |

FIG. 6 depicts another example embodiment of a separation column 60 in accordance with this disclosure. In this embodiment, the stationary phase is implemented by a field effect transistor. The field effect transistor includes a source electrode 61, a channel region 63, and a drain electrode 62, where the graphene forms the channel region of the field effect transistor. By adjusting the magnitude of the DC voltage applied to the gate electrode 64, the desorption rate between the analyte of interest and the graphene is controlled.

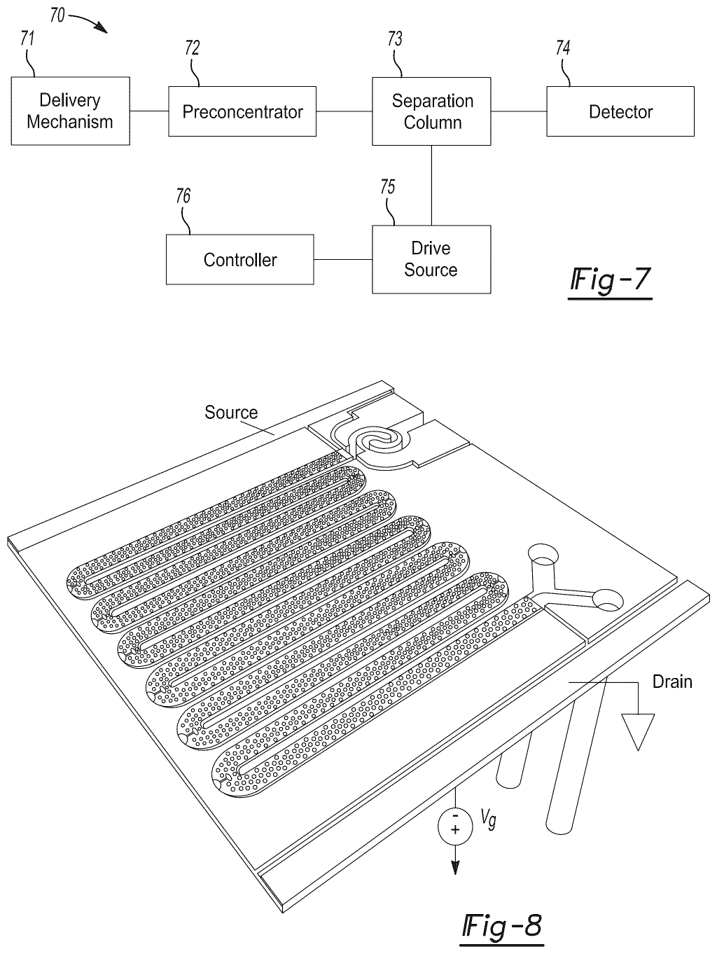

The separation column may be suitable for use in and/or integrated into a gas chromatograph 70 as shown in FIG. 7. The gas chromatograph includes one or more preconcentrators and one or more separation columns. In the simplified example, the gas chromatograph 70 is comprised on one preconcentrator 72 and one separation column 73. More specifically, the preconcentrator 72 includes a chamber through which the analyte passes with sorbent material in the chamber; whereas, the separation column 73 may be implemented in the manner described above. The gas chromatograph further includes a detector 74 disposed at the outlet of the separation column 73.

A delivery mechanism 71 is fluidly connected to the inlet of the preconcentrator 72 and operates to introduce an analyte of interest into gas chromatograph. A controller 76 is interfaced with the drive source 75 of the separation column 73 and operates to adjust magnitude of the DC voltage applied to the gate electrode, thereby controlling desorption rate in the separation column. It is to be understood that only the relevant components of the gas chromatograph are discussed in relation to FIG. 7, but that other components may be needed to control and manage the overall operation of the system.

To demonstrate the concept, the complex monolithic gas chromatography system was fabricated as seen in FIG. 8. The gas chromatography system included microcolumn with graphene made by chemical vapor deposition (CVD) as the stationary phase, injection loop and μPID (photoionization detector). The CVD graphene was first grown, transferred, and lithographically patterned onto a Si substrate with 275 nm dry thermal grown SiO₂ and ALD (atomic layer deposition) deposited 50 nm Al₂O₃, followed by the source/drain contact (Cr/Au/SiO₂) e-beam evaporation deposition and liftoff. The substrate dielectrics, which is not covered by graphene and metal contacts, were etched away via BHF (buffered hydrofluoric acid) wet etching and RIE (reactive ion etching) dry etching to expose the underneath Si substrate for anodic bonding with glass channel. Next, wafer-through DRIE (deep RIE) was conducted at the inlet ports and the μPID spiral channel. For the glass wafer, Cr/SiO₂ (150 nm/100 nm) was first deposited via e-beam evaporating and wet etched, working as a hard mask for the BHF wet etching and dry etching to define the ˜12 μm high flow channel. The hard mask and the photoresist were then stripped away. Finally, the glass channel and the die with Gr-FET was anodic bonded to form the gas channel.

The Gr-based column with 69 cm in length, 250 μm in width, and 12 μm in height was formed with graphene as the bottom inner sidewall and the anodic bonded glass channel as the other three inner sidewalls. A μPID was integrated as a gas sensor to monitor the analytes eluted out of the column. An injection loop was formed by inserting a short guard column into the inlet for the sample injection. Briefly, test sample was first drawn into the short guard column (˜1.5 cm) via turning on the pump before being pushed into the system by the carrier gas flow (Helium). The flow velocity was typically 7 cm/sec. Narrow electrodes (Cr/Au) covered by silicone oxide was pattered in an interdigitated structure on the edge of the graphene channel with the width and length ratio kept at ˜1:1. Graphene was grounded and gate voltage was altered during the V_{g}-dependent measurement. All the measurements were conducted under ambient conditions, i.e., 20° C., 1 atm.

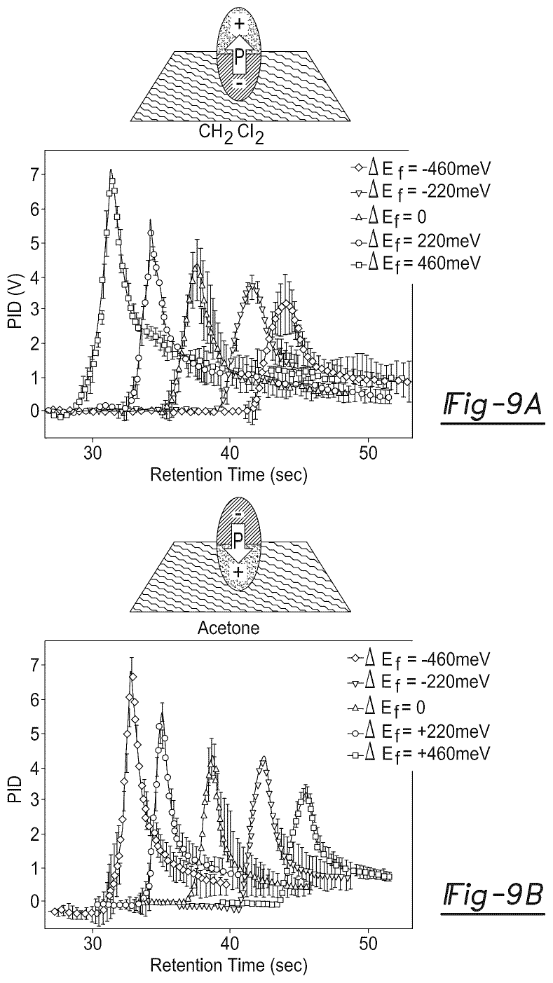

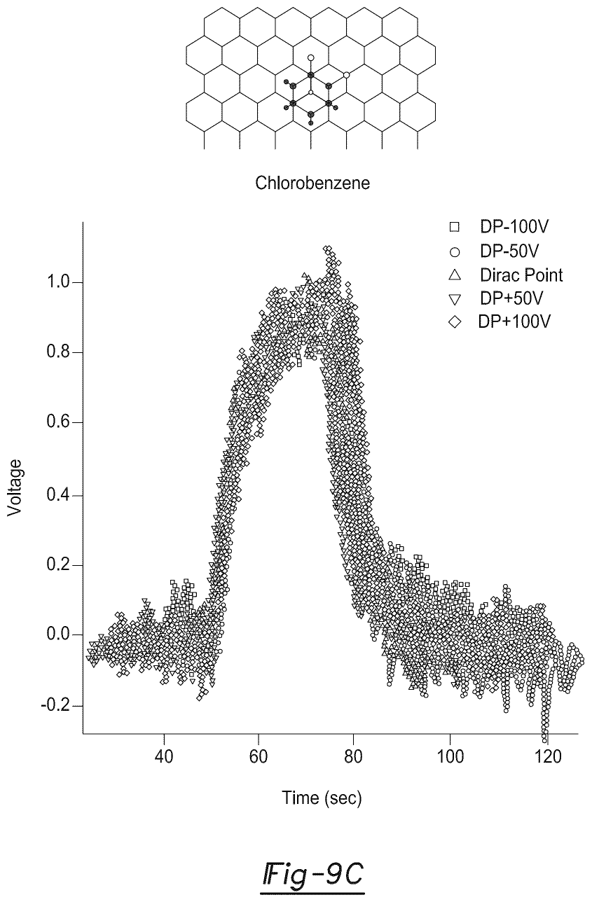

In order to characterize the figure of merits of the gas chromatography system, including the retention factor (k) and the plate numbers (N), Vg-dependent single-species chromatogram was measured at room temperature, as exemplified in FIGS. 9A-9C. Retention time was drastically altered with polar analytes through electrostatic gating and thus the graphene Fermi level shift without the need of changing substrate temperature. No obvious gate dependency was observed with aromatics like chlorobenzene.

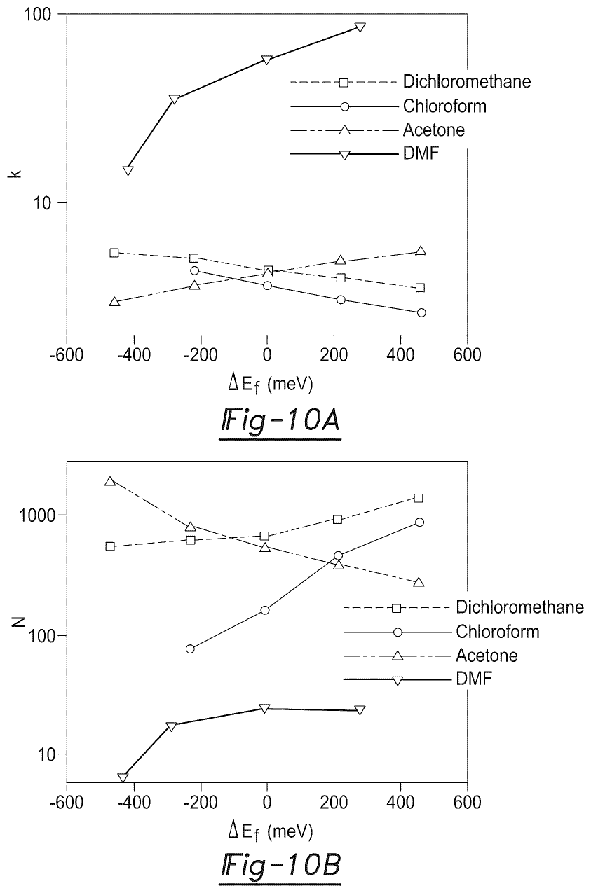

It is clear that more positive gate voltage and higher Fermi levels lead to a shorter retention time of CH₂Cl₂, whose electronegative side is statistically closer to graphene, by weakening the binding energy and accelerating the desorption process. For the molecules like DMF, active gate tuning was observed once again but with the opposite trend. A higher Fermi level slows down the desorption rate and increases the retention time. The extracted values of k and N are summarized in FIGS. 10A and 10B.

The correlation between the Fermi level shift and the partition coefficient K was also established by fitting with extracted binding energy, which is equivalent to the enthalpy change and the calculated entropy change. Again, the opposite trend was observed for polar species with the opposite dipole orientation.

In order to investigate the gate tuning effect on the separation performance, resolution (R) was extracted via Vg-dependent two-species chromatogram.

$$R = \frac{\vert {t}_{R} ( A ) - {t}_{R} ( B ) \vert}{w ( A ) + w ( B )} , \qquad ( 9 )$$

where t_{R}(A) and t_{R}(B) is the retention time of two species. w(A) and w(B) is the corresponding peak width.

Three pair of mixtures with different volatility and gate tuning tendency was investigated with results listed in Table 3. In particular, the elution order was observed to cross over for the pair of CHCl₃ and acetone, which would not happen in conventional temperature-programming GC, as each individual peak is often equally or closely affected by temperature variation, and thus the peaks' elution order remain the same.

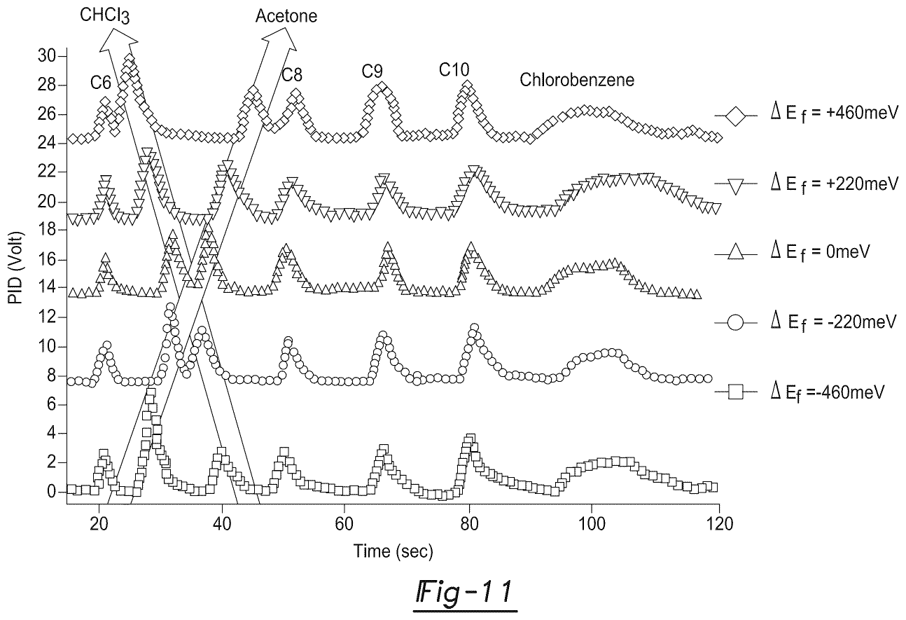

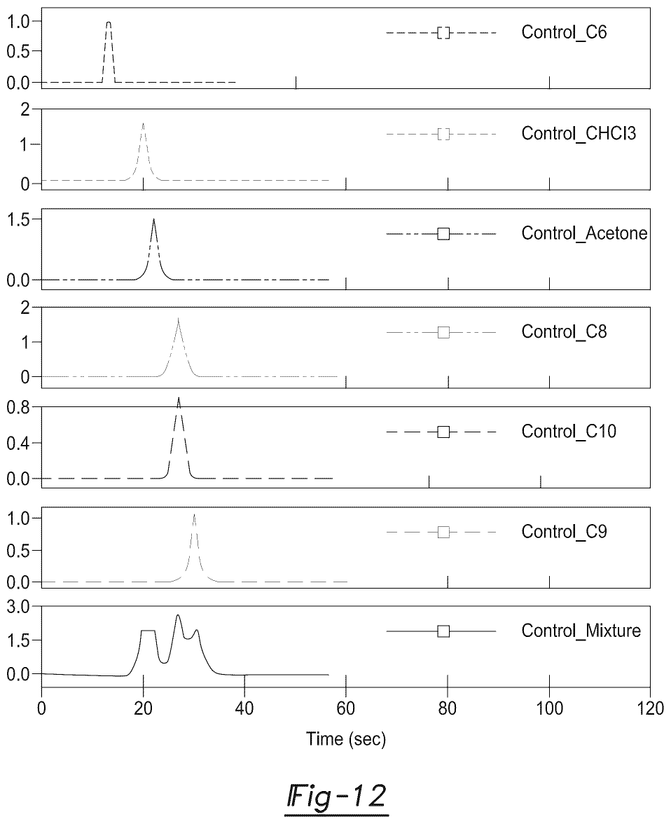

FIG. 11 summarized the performance of Gr-based GC system in multi-species separation. Again, there is obvious gate dependency with polar analytes (chloroform, acetone) but no obvious dependency was observed with non-polar species (alkanes) and aromatics (chlorobenzene). The retention time of the separated component in the Gr-based GC system was much longer than in the control experiment (FIG. 12) where the GC system had the same structure and measurement scheme except that the bottom inner sidewall in the column was just the substrate (Al₂O₃ and SiO₂) instead of graphene. The mixture was also poorly separated in the control experiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A separation column for use in gas chromatography, comprising:
an enclosure having an inlet configured to receive an analyte of interest, an outlet and a flow channel defined between the inlet and the outlet;
graphene disposed on at least one surface defining the flow channel in the enclosure;
a gate electrode electrically coupled to the graphene; and
a drive source electrically coupled to the gate electrode and configured to apply a DC voltage.

2. The separation column of claim 1 further comprises a controller interfaced with the drive source and operates to adjust magnitude of the DC voltage applied to the gate electrode, thereby controlling analyte's desorption rate in the separation column.

3. The separation column of claim 1 further comprises a field effect transistor having a source electrode, a channel region, and a drain electrode, where the graphene forms the channel region of the field effect transistor.

4. The separation column of claim 1 wherein the flow channel has a serpentine shape.

5. The separation column of claim 1 further comprises a delivery mechanism fluidly connected to the inlet of the enclosure and introduces the analyte of interest into the flow channel of the enclosure.

6. The separation column of claim 1 is integrated into a gas chromatograph.

7. A gas chromatograph, comprising:
a separation column having an inlet, an outlet and a flow channel defined between the inlet and the outlet;
a delivery mechanism fluidly connected to the inlet of the separation column and operates to introduce an analyte of interest into the flow channel of the separation column; and
a detector disposed at the outlet of the separation column,
wherein the separation column includes graphene disposed on at least one surface defining the flow channel, a gate electrode electrically coupled to the graphene;
and a drive source electrically coupled to the gate electrode and configured to apply a DC voltage thereto.

8. The gas chromatograph of claim 7 further comprises a controller interfaced with the drive source and operates to adjust magnitude of the DC voltage applied to the gate electrode, thereby controlling desorption rate in the separation column.

9. The gas chromatograph of claim 7 further comprises a field effect transistor having a source electrode, a channel region, and a drain electrode, where the graphene forms the channel region of the field effect transistor.

10. The gas chromatograph of claim 7 wherein the flow channel has a serpentine shape.

11. The gas chromatograph of claim 7 further comprises preconcentrator fluidly connected between the delivery mechanism and the separation column, where the preconcentrator includes a chamber through which the analyte passes and sorbent material in the chamber.

12. A separation column for use in gas chromatography, comprising:
a substrate;
an enclosure formed on the substrate, wherein the enclosure provides an inlet configured to receive an analyte of interest, an outlet and a flow channel defined between the inlet and the outlet; and
graphene disposed on at least one surface defining the flow channel in the enclosure.

13. The separation column of claim 12 further comprises a temperature tuning mechanism disposed proximate to the flow channel, wherein the temperature tuning mechanism operates to change ambient temperature and thereby controls analyte's desorption rate in the flow channel.

14. The separation column of claim 12 further comprises a gate electrode electrically coupled to the graphene;
a drive source electrically coupled to the gate electrode and configured to apply a DC voltage thereto; and
a controller interfaced with the drive source and operates to adjust magnitude of the DC voltage applied to the gate electrode, thereby controlling analyte's desorption rate in the separation column.

15. The separation column of claim 12 wherein the flow channel has a serpentine shape.

16. The separation column of claim 12 further comprises a delivery mechanism fluidly connected to the inlet of the enclosure and introduces the analyte of interest into the flow channel of the enclosure.

17. The separation column of claim 12 is integrated into a gas chromatograph.
